(19) United States
(12) Patent Application Publication
(10) Pub. No.: US 2007/0088454 A1
(43) Pub. Date: Apr. 19, 2007

(54) SYSTEM AND METHOD FOR TROUBLESHOOTING A MACHINE

(75) Inventors: Chandra Sekhar Jalluri, Canton, MI (US); Prashanth Magadi, Ypsilanti, MI (US); Ingrid Kaufman, Eden Prairie, MN (US); Mohan Subbaraman Viswanathan, Canton, MI (US); Paul Charles Edie, Troy, MI (US); Robert Louis Ratze, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/609,592

(22) Filed: Dec. 12, 2006

Related U.S. Application Data
(63) Continuation-in-part of application No. 11/161,417, filed on Aug. 2, 2005.
Application No. 11/161,417 is a continuation-in-part of application No. 10/904,119, filed on Oct. 25, 2004.

(51) Int. Cl. G06F 19/00

(52) U.S. Cl. 700/159

(57) ABSTRACT

A system and method for troubleshooting a operation of a machine include performing an initial, operator based analysis in response to an alarm indicator output by a processing unit monitoring the machine operation. The method uses a query-based analysis to guide the operator. A secondary analysis is used if the initial analysis does not yield the cause of the alarm. The secondary analysis can include a number of steps, including analyzing raw vibration data or trend lines generated from the raw data. If the trend lines are operation specific, a particular operation or particular tool may be identified as the cause of the alarm, and appropriate action can be taken. A tertiary analysis can also be used if the initial and secondary analyses do not yield the cause of the alarm.

### CROSS-REFERENCE TO RELATED APPLICATIONS

This application is a continuation-in-part of U.S. application Ser. No. 11/161,417 filed Aug. 2, 2005, which is a continuation-in-part of U.S. application Ser. No. 10/904,119 filed Oct. 25, 2004, each of which is hereby incorporated herein by reference.

### BACKGROUND OF THE INVENTION

1. Field of the Invention

The present invention relates to a system and method for troubleshooting a machine.

2. Background Art

The ever-increasing emphasis on product quality continues to put pressure on manufacturers to find new ways to produce high quality products without increasing production time or otherwise increasing manufacturing costs. Inherent in this high quality, low cost dichotomy is a need to reduce scrap, while obtaining the longest possible life from manufacturing tools and equipment. Manufacturing machines, often referred to as “machine tools”, include a wide variety of machines and equipment, such as milling machines, lathes, and other metal cutting and non-metal cutting manufacturing machines. Increasing the number of tooling changes and/or decreasing the time between machine tool maintenance may increase product quality, but it may result in an unnecessary increase in tooling costs and/or lost production time.

Over time, manufacturers have developed systems and methods of predictive and preventative maintenance. Such systems may include a scheduled tool change based on a number of parts produced, or scheduled machine down time, during which bearings and other components may be replaced prior to their having an adverse effect on product quality. In order to implement these systems in a cost effective manner, or to reduce the frequency of these preventative maintenance tasks, decision-makers need information. In particular, information that is indicative of historical trends is useful, so that accurate predictions can be made regarding future production runs. In addition, the ability to isolate particular problem areas is also useful; this helps to concentrate efforts where they will have the most impact and produce the most benefit.

Toward this end, manufacturers have continued to analyze machine tools and their associated components in an effort to gather information they can use to make efficacious decisions regarding their production systems and processes. One type of machine tool analysis used is a vibration analysis. Information gathered from this type of analysis may be indicative of a variety of different production problems.

One system and method of characterizing a machining process using vibration signatures of machines is described in U.S. Pat. No. 5,663,894, issued to Seth et al. on Sep. 2, 1997, which is hereby incorporated herein by reference. Seth et al. describes a machine condition signature analysis (MCSA), in which the vibration signatures of machines are characterized by discriminating vibration activity at various positions on the machines. This is done with and without machining loads. Both time and frequency domain analyses may then be stored in a database for future comparison and tracking. Although a technique such as MCSA may be effective to identify potential problems with a machine, it can be a relatively complex process that requires highly trained individuals to properly execute the analyses.

One alternative to using MCSA is described in U.S. Pat. No. 6,845,340 issued to Edie et al. on Jan. 18, 2005, which is hereby incorporated herein by reference. Edie et al. describes a system and method for machining data management, which use vibration data from a machine to generate operation specific vibration profiles. These profiles can be used to generate operation specific data lines, from which a data matrix can be created to provide information useful in an analysis of the machine. One of the uses for such data is to determine an appropriate fault level for various machine operations. If during operation of the machine a vibration level reaches a fault level, a warning or alarm may be provided to indicate a potential problem with the machine.

Although the systems and methods described above may provide a first step toward machine health monitoring and preventative maintenance—i.e., the systems and methods gather data to provide warning or alarm indicators of potential problems—a useful next step is to use the data gathered to pinpoint specific areas of concern related to the machine and its operation. As discussed above, the use of MCSA to troubleshoot a machine may require highly trained personnel to properly implement the MCSA techniques. Moreover, some of the MCSA techniques may require the machine to be taken off line, so that production time is lost.

Therefore, it would be desirable to have a system and method of troubleshooting a machine that relies on data that is automatically gathered and processed while the machine is operating. It would also be desirable to have a system and method of troubleshooting a machine that includes a tiered analysis structure, starting with, for example, an initial analysis performed by the machine operator, and moving through increasing levels of analytical sophistication.

### SUMMARY OF THE INVENTION

To overcome the shortcomings of prior art troubleshooting systems and methods for machines, embodiments of the present invention provide a tiered structure, starting with an initial analysis performed by the machine operator, and moving through one or more additional levels of analysis as needed or desired. The trigger for any of the troubleshooting analyses may be a warning, an alarm, or other indicator provided by a processing unit or other control system indicating that action should be taken. To aid a machine operator, an information screen can be provided, for example, on a personal computer (PC) or workstation display at or near the machine. The alarm and warning messages can also be configured to be simultaneously sent to a plant floor information system, pagers of plant personnel, electronic message boards, a web interface, or some combination thereof. In addition, a query screen can be sent to the operator to ask a series of questions, the answers to which can be input by the operator at the PC or workstation. The question and answer format provides an initial level of analysis that can lead the operator to pinpoint the problem or potential problem at an early stage of the analysis.

If the cause of the problem is determined in the initial analysis, the method may end with the operator alerting the appropriate individuals to take necessary action. If the cause of the problem is not determined in the initial analysis, a secondary analysis can be performed. The secondary analysis can include a number of steps, such as analyzing raw vibration data or trend lines generated from the raw data. If the trend lines are operation specific, a particular operation or particular tool may be identified as the cause of the alarm, and appropriate action can be taken.

If the data analyses do not provide information leading to the cause of the problem, certain operations of the machine can be performed by running the machine through one or more predetermined operations, and analyzing the outcome. For example, in the case of a milling machine having a rotating spindle and one or more slides for linear movement, the spindle and slides can be separately analyzed. For example, vibration data can be collected during operation of the spindle only, or operation of one of the slides while the spindle is not rotating. In the case of the mill, or other metal cutting machine, these operations can be performed without cutting a workpiece, or they can be performed while a workpiece is being cut.

To the extent that neither the initial nor secondary analyses yields the cause of the alarm, a tertiary analysis may be performed. In this analysis, data gathered from the alarmed operation can be correlated with other data to try to determine deviation from acceptable limits. For example, the data collected during the alarmed operation can be compared to data previously gathered from the same machine during the same or similar machining operations. Conversely, data from the alarmed operation can be correlated to data from different machines taken at the same time, or at different times while performing the same or similar operation. Finally, if the cause is still not determined, an MCSA or other analysis can be performed.

### BRIEF DESCRIPTION OF THE DRAWINGS

FIG. 1 is a schematic representation of a system for troubleshooting a machine in accordance with an embodiment of the present invention;

FIG. 2 is a flowchart illustrating a method of troubleshooting a machine in accordance with an embodiment of the present invention; and

FIGS. 3A and 3B show a flowchart illustrating details of the steps shown in the flowchart in FIG. 2.

### DETAILED DESCRIPTION EMBODIMENTS OF THE INVENTION

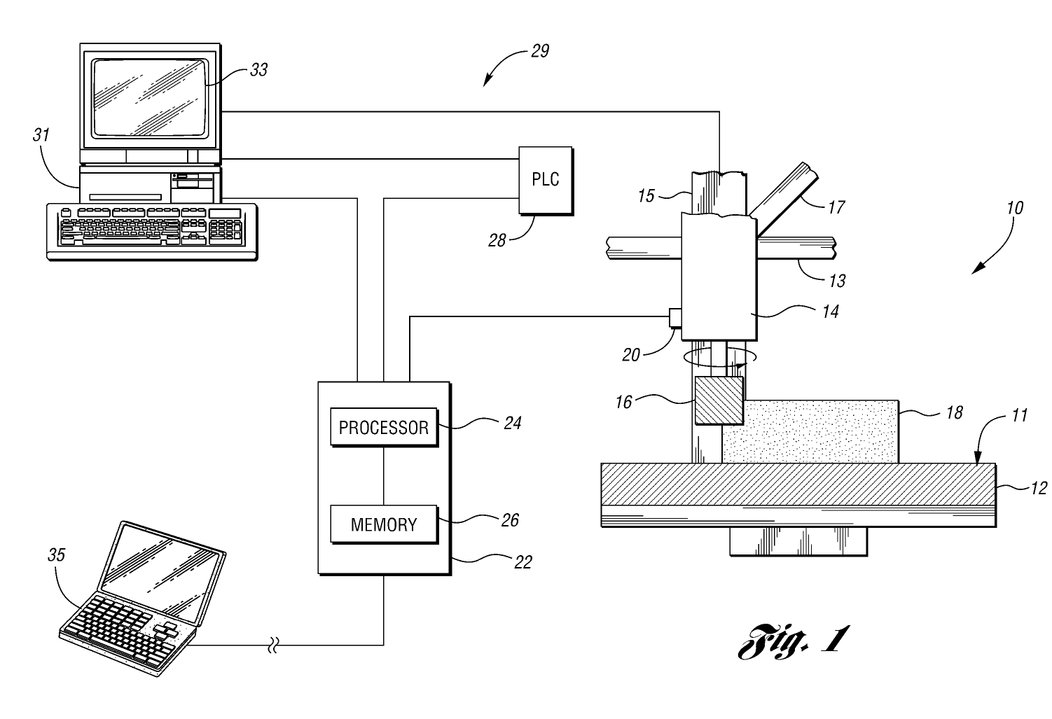

FIG. 1 illustrates a system 10 for troubleshooting operation of a manufacturing machine, or machine tool 11. The machine tool 11 includes a bed 12 and a spindle 14. In addition, there are three slides 13, 15, 17, which are operable to effect a movement of the spindle 14 along an x-axis, a y-axis, and a z-axis, respectively. Of course, a machine tool may have slides for effecting movements of other portions of the machine tool; for example, slides 19, 21 facilitate movement of the bed 12 of the machine tool 11. The machine tool 11, shown in FIG. 1, is a computer numerical control (CNC) milling machine. As will readily be discerned from the description below, the present invention can be used with virtually any type of machine tool, including manual as well as CNC machines.

Mounted in the spindle 14 is a cutting tool 16 which is used to machine a workpiece 18. Attached to the spindle 14 is a vibration sensor 20 that is configured to sense vibrations in the spindle 14 and output signals related to the vibrations to a processing unit 22. The vibration sensor 20 may be chosen from any one of a number of types of vibration sensors, such as an accelerometer, a velocity sensor, or any other suitable sensor capable of sensing vibrations.

Of course, other types of sensors may be used—i.e., ones that sense machine operation parameters other than vibrations. For example, a current sensor may be used to measure changes in the amount of current the machine tool 11 draws during various operations. Similarly, a thermocouple, or other type of temperature sensor, could be used to detect changes in temperature of some portion of the machine tool 11. The spindle speed, torque, or feed rate could also be sensed to provide information relating to the operations. Indeed, any sensor capable of sensing a machine operation parameter can be used to send signals to the processing unit 22.

The processing unit 22 may be conveniently mounted directly on a portion of the machine tool 11, and includes a processor 24 and a memory 26. The processor 24 may be programmed to perform specific instruction sets on data, such as vibration data received from the sensor 20. A controller, such as a programmable logic controller, or PLC 28, is also attached to the machine tool 11, and may be programmed with information specific to the machine tool 11, or specific to a machining operation, non-machining operation, or operation cycle performed by the machine tool 11. The processor 24 and the memory 26 are both operatively connected to the sensor 20 and the PLC 28, such that data may be transferred among them.

The PLC 28 is part of a control system 29 which also includes a computer 31 having an operator display 33 that can be used by the machine tool operator to input commands to the machine tool 11, and receive information from the machine tool 11. As described in detail below, the computer 31 also receives information from the processing unit 22, such as warnings or alarms related to operation of the machine tool 11. Although the computer 31, as shown in FIG. 1, is a desktop computer, this element of the system 10 may be in the form of a control panel or other such device capable of providing information to the machine tool 11.

As shown in FIG. 1, another computer 35 is also connected to the processing unit 22. The computer 35 may be connected to the processing unit 22 at some far removed distance from the machine tool 11. In fact, it is contemplated that the computer 35 may be located off-site from the machine tool 11, and connected to the processing unit 22 through an intranet or through the internet. Although the computer 35 is shown in FIG. 1 as a single notebook computer, it is contemplated that the processing unit 22 may be connected to a broader network, such that many output devices, like the computer 35, could simultaneously access information from the processing unit 22.

As noted above, the PLC 28 may be programmed with information regarding particular non-machining cycles outside an operation cycle to determine the health of spindle 14 and the slides 13, 15, 17, 19, 21. The PLC 28 is configured to output to the processing unit 22 signals related to the machine operations. For example, if the spindle 14 is instructed to rotate at different speeds, the PLC 28 can, among other things, output signals to the processing unit 22 delineating different portions of the cycle. The cycle may include the spindle 14 accelerating to a particular speed, rotating at a particular speed and decelerating from a particular speed. The PLC 28 can provide a signal whenever the speed event starts or finishes. As explained below, this allows vibration signals from the sensor 20 to be associated with particular spindle speed events.

The PLC 28 may send a tool pickup signal each time a different tool is used in a set of machining operations. The PLC 28 may also send signals indicating when a particular cutting tool, such as the cutting tool 16, is performing a particular machining operation. In addition, the PLC 28 may communicate to the processing unit 22 when the machine tool 11 is idling, and may further communicate time related data such as the number of machining cycles performed or the number of the workpiece being machined. Thus, by outputting signals related to the machining and non-machining operations, the PLC 28 may communicate to the processing unit 22 tool-specific data, idling data, machining and non-machining data, and time related data, just to name a few. Of course, the specific information output from the PLC 28 to the processing unit 22 may vary, depending on the type and quantity of information desired.

As noted above, the computer 31 provides a mechanism for an operator of the machine tool 11 to input commands to operate the machine tool 11, including commands that are in the form of a predetermined computer program that may reside on the computer 31, or in a storage location accessible by the computer 31. In addition to programs that operate the machine tool 11 to perform machining operations on a workpiece, such as the workpiece 18, non-machining programs may also be executed by the computer 31 to operate the machine tool 11. These non-machining programs may be used, for example, as part of a method for troubleshooting the machine tool 11.

As explained below, the computer 31 may execute a predetermined program that controls operation of the machine tool 11 to effect movement of at least a portion of the machine tool 11—e.g., the spindle 14 or one of the slides 13, 15, 17, 19, 21—so that data can be gathered and analyzed for specific components of the machine tool 11. This can be an aid in determining a root cause of a warning or alarm, for example, output by the processing unit 22 during operation of the machine tool 11.

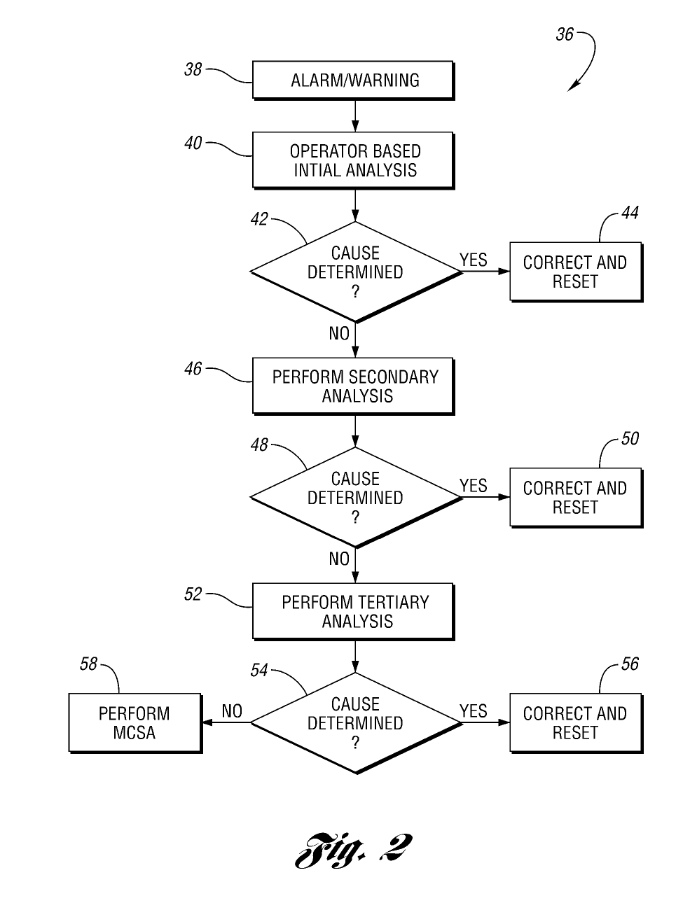

FIG. 2 shows a high-level flowchart 36 illustrating an embodiment of a method in accordance with the present invention. The method for troubleshooting operation of a machine, such as the machine tool 11 shown in FIG. 1, starts with an alarm or warning indicator at step 38. The system 10 shown in FIG. 1 is used for reference when describing the steps of the flowchart 36. The alarm or warning may be output by the processing unit 22 to the operator display 33. The processing unit 22 then outputs information so that an initial analysis can be performed by the operator.

In addition to information, which does not prompt the operator to take specific actions, the processing unit 22 can also output information that does prompt the operator to take action, for example, by providing information in the form of queries. This query driven information asks the operator a number of questions, the answers to which may lead to a determination of the cause of the alarm. The information provided to the operator, including the query driven information is part of an initial analysis, which may eliminate the need for further analysis—see step 40.

At decision block 42, it is determined whether the cause of the alarm was determined during the initial analysis. If the answer is yes, corrective action is taken and the alarm is reset—see step 44. If the answer is no, a secondary analysis is performed at step 46. As described in detail below, the secondary analysis may include a number of steps, such as analyzing trend data for cutting or non-cutting operations, or operating the machine tool 11 in a certain predetermined sequence to determine if components of the machine tool 11—e.g., the spindle 14 or one of the slides 13,115, 17, 19, 21 are functioning properly. If the secondary analysis yields the cause of the alarm—see decision block 48—then the problem is corrected and the alarm reset—see step 50.

If the cause of the alarm is not determined during either the initial or secondary analysis, a tertiary analysis is performed at step 52. The tertiary analysis may include such steps as correlating data from the alarmed operation—i.e., the operation during which the alarm indicator was sent—with other data to determine differences. The other data can be historical data from when the machine tool 11 previously ran the alarmed operation. Alternatively, it may be information from another machine tool running the same operation as the alarmed operation, or which is otherwise similarly situated as the machine tool 11 so as to make a direct comparison of data relevant to troubleshooting the alarm on the machine tool 11. If the cause of the alarm is determined during the tertiary analysis, the problem is corrected and the alarm reset at step 56. If, however, the cause of the alarm is not determined during the tertiary analysis, an MCSA or other complex analysis may need to be performed—see step 58.

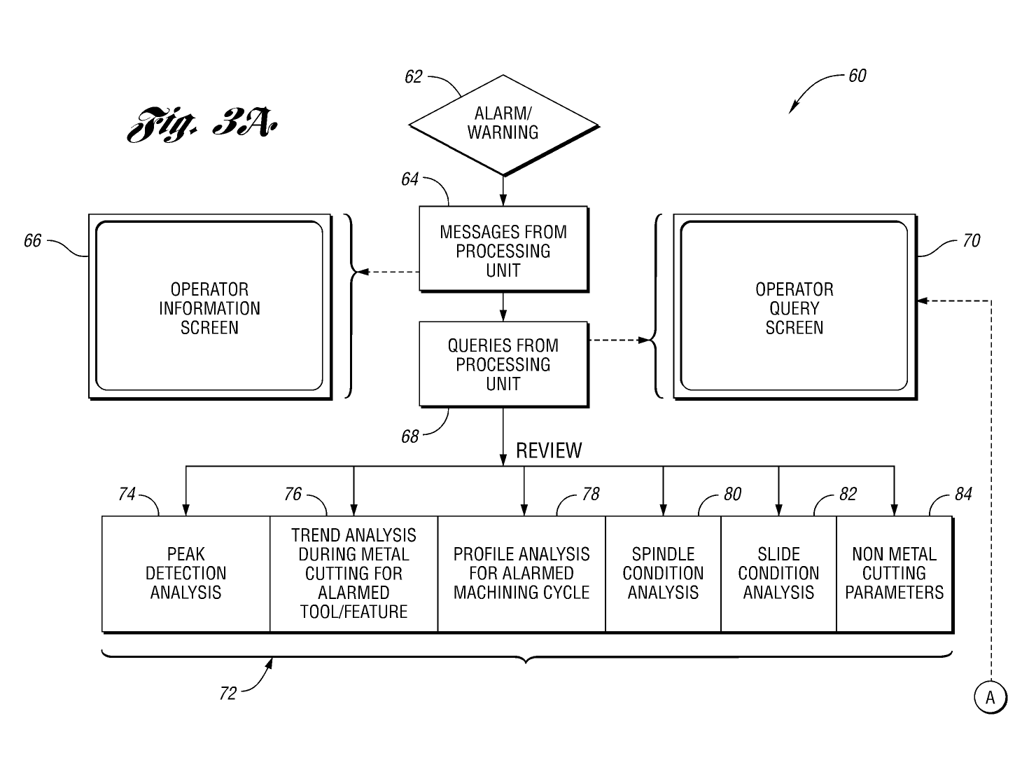

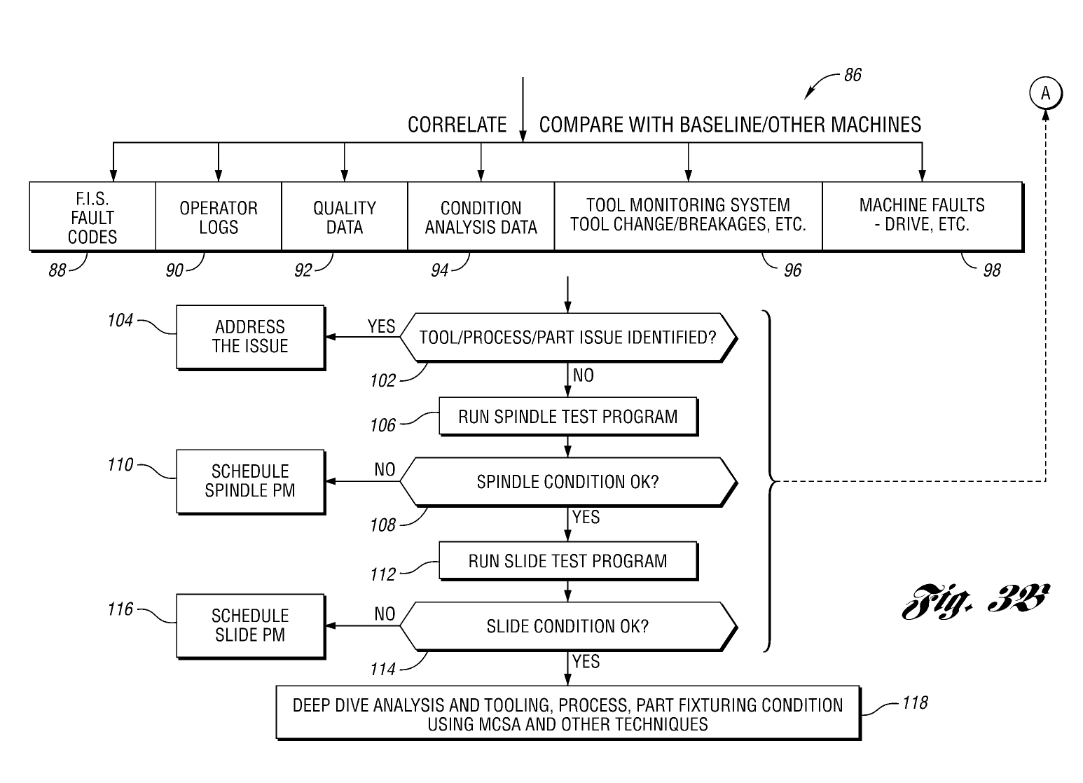

FIG. 3 shows a flowchart 60 illustrating a more detailed version of the method shown in FIG. 2. Again, the system 10 shown in FIG. 1 will be used for reference. At step 62, an alarm or warning is sent, for example, from the processing unit 22. The initial analysis includes sending messages from the processing unit 22—see step 64—to an operator information screen 66, which is a screen that can be provided, for example, on the operator display 33. The information provided on screen 66 does not prompt the operator to take action. It may include such things as the type of fault—e.g., short term, long term, etc.—that caused the alarm.

The information may also include a type of statistical parameter that was used to characterize the fault. For example, vibration data can be characterized in terms of a root mean square, kurtosis, or other parametric representation that facilitates data analysis. The information on the screen 66 may also include a date and time stamp for the alarm, a tool number to identify the particular cutting tool being used when the fault occurred, or a particular operation being performed when the fault occurred.

At step 68, a number of queries are sent to an operator query screen 70, which may also be provided on the operator display 33. The “queries” may be in the form of questions, or they may be in the form of prompts, instructing the operator to take certain action. For example, the queries may ask whether the operator observed any gross or obvious issues, such as a cutting tool being out of position, or an obstacle present in the cutting area. The queries may ask to operator to open a tool magazine to check the alarmed tool. To the extent that the operator answers the queries such that the cause of the alarm is determined, the queries may further ask the operator to schedule the appropriate maintenance.

If the initial analysis does not yield the cause of the alarm, the secondary analysis—shown generally at 72—is performed. During the secondary analysis, a manufacturing supervisor, an engineer, or personnel other than the machine operator may perform some or all of the steps. At step 74, machine operation parameter data—e.g., peaks of vibration data—may be examined to determine if a transient spike is present that indicates a relatively large deviation from expected values. This can be indicative of a crash of the machine tool 11, for example, if the cutting tool goes off path and hits the workpiece 18 unexpectedly.

At step 76, a trend analysis can be performed, looking at trend data for metal cutting of operations using the alarmed tool, or operations cutting the alarmed feature. In addition, at step 78, a profile analysis can be performed on the alarmed machining cycle. Specifically, the data profiles—i.e., vibration or other data—can be examined for the entire machining cycle that was being performed when the alarm occurred. This can help determine if a problem actually started before the alarm, but did not reach the fault level until later in the machining cycle.

At steps 80 and 82, the machine tool 11 can be operated according to certain predetermined steps to determine if the alarm or fault condition was a result of a problem with the machine tool operation. Although the spindle condition analysis program indicated at block 80 may take on a number of different forms depending on the data that is desired, one effective spindle analysis program is given as an example here. At the start of the spindle analysis program, the spindle 14 is not moving. It can then be ramped up to a first predetermined speed, where it is held in a steady state condition at the first predetermined speed for some predetermined amount of time. It has been found that 30 seconds is a convenient time to use, providing enough information about the spindle movement, without using too much machine time. Of course, other time intervals may be used, as desired.

Once the spindle 14 has been operated at the first predetermined speed for the first predetermined amount of time, it is ramped down until it stops. It is worth noting that the spindle 14 does not need to start at a zero speed, nor finish at a zero speed, though these are convenient starting and ending points for purposes of delineating various operating conditions. The operation of the spindle 14 as discussed above, provides a vibration profile that includes an acceleration portion, a steady speed portion, and a deceleration portion. Signals output from the PLC 28 can be associated with the vibration data gathered from the sensor 20 so that movement-specific data profiles can be defined.

Raw data from the sensor 20 and the PLC 28 is acquired, and this data is then associated to define a movement-specific data profile for the movement of the spindle 14. An algorithm is applied to the raw data to generate a parametric representation of the vibration data, for example, a maximum, a minimum, an average, an average root mean square (RMS), a maximum RMS, a minimum RMS, and an RMS summation. As noted above, the vibration data is associated with information from the PLC 28 to define movement-specific data profiles for the data gathered. Thus, when the parametric representation of the raw data is computed, the algorithm can be used to generate one or more movement-specific data points, which can later be used to generate one or more movement-specific trend lines.

After the parametric representation of the vibration data is generated, the raw data can be dumped, thereby conserving storage space and bandwidth as the data is transferred. The steps described above can continue until the spindle analysis program is complete. The spindle analysis program being described herein for exemplary purposes, includes two additional operations of the spindle 14. In particular, the spindle 14 is again accelerated from zero, but this time it is accelerated to a second predetermined speed, where it is held at steady state for a second predetermined amount of time. It is worth noting that the second predetermined amount of time may be different from the first predetermined amount of time, or it may be the same, for example, 30 seconds. After the second predetermined period of time has elapsed, the spindle 14 is decelerated to zero. The data is then processed, and the method loops back to acquire more data.

In the exemplary method described herein, the spindle condition analysis program includes a third operation of the spindle 14, during which it is accelerated from zero to a third predetermined speed, maintained at that speed for a third predetermined amount of time, and then decelerated to zero. Again, the third predetermined amount of time may be the same or different from the first and second predetermined amounts of time. Operating the spindle 14 at three different speeds, including accelerations and decelerations, may provide evidence of component wear that might not otherwise be detected if the spindle 14 was operated only at a single speed. In this example, the spindle condition analysis ends after the third operation.

Similar to the spindle condition analysis, a slide condition analysis can also be run to examine the health of any or all of the slides 13, 15, 17, 19, 21. One example of a slide condition analysis tests all three of the spindle slides 13, 15, 17 separately and in combination. It is understood, however, that a slide condition analysis does not need to include all three spindle slides 13, 15, 17, and it can also be applied to the machine bed slides 19, 21.

In one example of the slide condition analysis, the sensor 20 and the PLC 28 provide signals which are used in the subsequent data collection. Initially, the x-axis slide 13 is operated and raw vibration data gathered. It may be convenient to operate the slide 13 at a rapid rate, and over a long range of travel. It is worth noting, however, that different rates and lengths of travel can be used. The raw data information received from the sensor 20 and the PLC 28 has an algorithm applied to it, and parametric representation of the data is generated. The raw data is then dumped to conserve space and bandwidth.

Next, the y-axis slide 15 and the z-axis slide 17 are operated in turn, and data collected as above. Finally, all three slides 13, 15, 17 are operated simultaneously, and the slide condition analysis program is ended. It is worth noting that the slide test program not only provides information about a particular slide as that slide moves, but also provides information on the cross-transmissivity between slides. For example, movement of the y-axis slide 15 may cause a vibration in the x-axis slide 13 which is detected by the sensor 20. The effect on the slide 13 of movement of the slide 15, is an indicator of the cross-transmissivity between the x- and y-axis slides 13, 15.

At step 84 non-metal cutting parameters can be analyzed. For example, during a machining cycle there are times when metal is not being cut, but the machine tool 11 is operating. These non-metal cutting parameters can include such things as spindle and slide movements, tool changes, tool movement between different features, air seat check for tool integrity, tool clamping, etc. An examination of these operations can also be helpful in determining the cause of a fault condition that occurs during machine operation.

If the cause of the fault condition or alarm is not determined in the secondary analysis, the present invention contemplates using a tertiary analysis. The tertiary analysis, indicated generally at 86, correlates with other data the data from the operation of the machine tool 11 during the fault condition. The other data can be taken from the machine tool 11 itself during other, non-alarmed operations, or the other data can be taken from other machines similarly situated to the machine tool 11.

At step 88, fault codes can be analyzed for the machine tool 11, as well as for other machines. This type of data may be collected, for example, by the processing unit 22, or to by other factory information systems (FIS). In addition, operator logs 90 can be examined to determine if the operators of the machine tool 11 noted anything unusual that could indicate the cause of the alarm. At step 92 quality data can be examined. This may include statistical process control (SPC) data that is often collected during manufacturing operations.

Step 94 uses the results of the spindle or slide condition analysis program to help determine if the spindle or slide was operating within acceptable limits. In addition to the FIS used in step 88, some manufacturing facilities use a tool monitoring system that collects and stores data related to tool change frequency, breakages, etc. This data can also be analyzed, for example, at step 96. At step 98, a history of known machine faults is analyzed to determine if there is a pattern or trend that can be discerned that would indicate a cause for the alarm or fault condition.

Shown generally at 100 are a number of queries and instructions that can be provided at any point throughout the troubleshooting method of the present invention. As shown in FIG. 3, the queries and instructions 100 are provided in the operator query screen 70. The queries and instructions 100 can include a basic query asking if the problem was associated with a cutting tool, process, or part, and whether it was identified—see step 102. If the answer is “yes”, the instructions indicate at step 104 how to address the issue. If the answer is “no”, a spindle test program—e.g., the spindle condition analysis—may be performed at step 106.

If it is determined at decision block 108 that the spindle condition is not acceptable, a preventive maintenance (PM) is scheduled for the spindle—see step 110. If the spindle condition is determined to be within normal operating parameters, a slide test program—e.g., the slide condition analysis—may be performed on one or more of the slides at step 112. If it is determined at decision block 114 that the slide condition is not acceptable, a PM is scheduled at step 116. Finally, if the slides are all found to be working properly, an MCSA or other analytical technique may be used—see step 118.

While the best mode for carrying out the invention has been described in detail, those familiar with the art to which this invention relates will recognize various alternative designs and embodiments for practicing the invention as defined by the following claims.

What is claimed:

1. A method for troubleshooting operation of a machine operable to perform at least one machining operation on a workpiece, a sensor operatively connected to the machine is configured to sense a machine operation parameter during operation of the machine, a processing unit operatively connected to the sensor includes a processor and a memory, and is configured to receive and store data related to the machine operation parameter received from the sensor, the data including values of the machine operation parameter and trend data for both machining operations and non-machining operations, a controller operatively connected to the machine is configured to output to the processing unit data related to operation of the machine, the processing unit is further configured to correlate data from the sensor and data from the controller to facilitate retrieval of machine operation parameter data for specific cutting tools and specific operations of the machine, the processing unit being further configured to output a fault signal when a fault condition is indicated, a fault condition occurring when the sensed machine operation parameter data meets predetermined fault criteria, the method comprising:
sending information related to the fault to an operator of the machine, including at least one of: information indicating whether the fault was long term or short term, information identifying a statistical parameter used to characterize the machine operation parameter data, information indicating a time and date for when the fault was detected, information identifying a cutting tool in use when the fault condition occurs during a machining operation, or information identifying a machining operation being performed when the fault condition occurs during a machining operation;
sending query driven information to the operator of the machine, thereby guiding the operator through an initial analysis to determine the cause of the fault; and
performing a secondary analysis when the cause of the fault is not determined in the initial analysis, the secondary analysis including at least one of: determining if a transient spike in the values of the stored machine operation parameter data is present, analyzing trend data for machining operations, analyzing trend data for non-machining operations, or analyzing certain operations of the machine to determine if the fault includes a machine fault.

2. The method of claim 1, further comprising performing a tertiary analysis when the cause of the fault is not determined in either the initial analysis or the secondary analysis.

3. The method of claim 2, wherein the step of performing the tertiary analysis includes correlating data from the processing unit related to the fault condition with previously collected data related to at least one of the machine or operations performed by the machine.

4. The method of claim 3, wherein the previously collected data includes historical data related to operation of the machine to determine if operation of the machine during the fault condition deviated from historical operating conditions of the machine.

5. The method of claim 3, wherein the previously collected data includes data related to operation of other machines to determine if operation of the machine during the fault condition deviated from operating conditions of the other machines

6. The method of claim 1, wherein the step of sending query driven information to the operator of the machine includes querying the operator to determine if the cause of the fault is discernable by observation of the machine, including observation of a cutting tool outside of a predetermined location and observation of an obstacle present inhibiting operation of the machine.

7. The method of claim 1, the machine including a spindle configured to hold a cutting tool and a slide operable to effect a linear movement of a portion of the machine, and wherein the step of analyzing certain operations of the machine to determine if the fault includes a machine fault includes performing at least one of an analysis of the spindle or an analysis of the slide.

8. The method of claim 7, wherein the analysis of the spindle includes:
loading a cutting tool in the spindle, and operating the spindle in a first manner, including accelerating the spindle until it reaches a first spindle speed, operating the spindle at the first spindle speed for a first predetermined time, and decelerating the spindle, and
processing data from signals output from the sensor and from the controller while the spindle is operated in the first manner to define a spindle data profile for the machine having an acceleration portion, a steady speed portion, and a deceleration portion corresponding to the respective movements of the spindle as it is operated in the first manner.

9. The method of claim 7, wherein the analysis of the slide includes operating the slide, and processing data from signals output from the sensor and from the controller while the slide is operated to define a slide data profile.

10. A method for troubleshooting operation of a machine operable to perform at least one machining operation on a workpiece, a sensor operatively connected to the machine is configured to sense a machine operation parameter during operation of the machine, a processing unit operatively connected to the sensor includes a processor and a memory, and is configured to receive and store data related to the machine operation parameter received from the sensor, the data including values of the machine operation parameter and trend data for both machining operations and non-machining operations, a controller operatively connected to the machine is configured to output to the processing unit data related to operation of the machine, the processing unit is further configured to correlate data from the sensor and data from the controller to facilitate retrieval of machine operation parameter data for specific cutting tools and specific operations of the machine, the processing unit being further configured to output a fault signal when a fault condition is indicated, a fault condition occurring when the sensed machine operation parameter data meets predetermined fault criteria, the method comprising:
sending information related to the fault to an operator of the machine, thereby guiding the operator through an initial analysis to determine the cause of the fault; and
performing a secondary analysis when the cause of the fault is not determined in the initial analysis, the secondary analysis including at least one of the following steps:
analyzing the stored machine operation parameter data to determine if a transient spike in the values of the stored machine operation parameter is present, thereby indicating a crash of the machine,
analyzing trend data for machining operations when the fault condition occurs during a machining operation, the trend data including at least one of a trend based on the cutting tool in use when the fault condition occurred or the machining operation being performed when the fault condition occurred,
analyzing trend data for non-machining operations when the fault condition occurs during a non-machining operation, or
performing an analysis of certain operations of the machine to determine if the fault condition resulted from a machine fault.

11. The method of claim 10, wherein the step of sending information related to the fault to an operator of the machine includes sending information that does not prompt the operator to take action, and information that does prompt the operator to take action.

12. The method of claim 11, wherein the information sent to the operator that does not prompt the operator to take action includes at least one of the following:
information indicating whether the fault was long term or short term,
information identifying a statistical parameter used to characterize the machine operation parameter data,
information indicating a time and date for when the fault was detected,
information identifying a cutting tool in use when the fault condition occurs during a machining operation, or
information identifying a machining operation being performed when the fault condition occurs during a machining operation.

13. The method of claim 11, wherein the information sent to the operator that does prompt the operator to take action includes information indicating that the operator should determine if the cause of the fault is discernable by observation of the machine, including a cutting tool outside of a predetermined location and an obstacle present inhibiting operation of the machine.

14. The method of claim 10, the machine including a spindle configured to hold a cutting tool and a slide operable to effect a linear movement of a portion of the machine, and wherein the step of performing an analysis of certain operations of the machine includes performing at least one of an analysis of the spindle or an analysis of the slide.

15. The method of claim 14, wherein the analysis of the spindle includes:
loading a cutting tool in the spindle, and operating the spindle in a first manner, including accelerating the spindle until it reaches a first spindle speed, operating the spindle at the first spindle speed for a first predetermined time, and decelerating the spindle, and
processing data from signals output from the sensor and from the controller while the spindle is operated in the first manner to define a spindle data profile for the machine having an acceleration portion, a steady speed portion, and a deceleration portion corresponding to the respective movements of the spindle as it is operated in the first manner.

16. The method of claim 14, wherein the analysis of the slide includes operating the slide, and processing data from signals output from the sensor and from the controller while the slide is operated to define a slide data profile.

17. The method of claim 10, further comprising performing a tertiary analysis when the cause of the fault is not determined in either the initial analysis or in the secondary analysis, the tertiary analysis including correlating data from the processing unit related to the fault condition with previously collected data related to at least one of the machine or operations performed by the machine.

18. The method of claim 17, wherein the previously collected data includes historical data related to operation of the machine to determine if operation of the machine during the fault condition deviated from historical operating conditions of the machine.

19. The method of claim 17, wherein the previously collected data includes data related to operation of other machines to determine if operation of the machine during the fault condition deviated from operating conditions of the other machines.

20. A system for troubleshooting operation of a machine operable to perform at least one machining operation on a workpiece, a sensor operatively connected to the machine is configured to sense a machine operation parameter during operation of the machine, a controller operatively connected to the machine is configured to output data related to operation of the machine, the system comprising:
an operator display for displaying information related to operation of the machine; and
a processing unit operatively connected to the controller and the sensor, and including a processor and a memory, the processing unit being configured to:
receive and store data related to the machine operation parameter received from the sensor, the data including values of the machine operation parameter and trend data for both machining operations and non-machining operations,
correlate data from the sensor and data from the controller to facilitate retrieval of machine operation parameter data for specific cutting tools and specific operations of the machine,
output a fault signal when a fault condition is indicated, a fault condition occurring when the sensed machine operation parameter data meets predetermined fault criteria,
send information related to the fault to the operator display, including at least one of: information indicating whether the fault was long term or short term, information identifying a statistical parameter used to characterize the machine operation parameter data, information indicating a time and date for when the fault was detected, information identifying a cutting tool in use when the fault condition occurs during a machining operation, or information identifying a machining operation being performed when the fault condition occurs during a machining operation, and
sending query driven information to the operator display, thereby guiding the operator through an initial analysis to determine the cause of the fault, including querying the operator to determine if the cause of the fault is discernable by observation of the machine, including observation of a cutting tool outside of a predetermined location and observation of an obstacle present inhibiting operation of the machine.
